(19) United States
(12) Patent Application Publication
(10) Pub. No.: US 2026/0321231 A1
(43) Pub. Date: Oct. 15, 2026

(54) VIBE-GUIDED MUSIC GENERATION FOR VIDEO DATA

(71) Applicant: Adobe Inc., San Jose, CA (US)

(72) Inventors: Cristin Fraser, Seattle, WA (US); Nour Hammad, Pittsburgh, PA (US); Nicholas J. Bryan, Belmont, CA (US); Lubomira Assenova Dontcheva, Seattle, WA (US)

(73) Assignee: Adobe Inc., San Jose, CA (US)

(21) Appl. No.: 19/176,776

(22) Filed: Apr. 11, 2025

(51) Int. Cl. G10H 1/00; G11B 27/028

(52) U.S. Cl. CPC G10H 1/0025; G11B 27/028; G10H 2210/111; G10H 2240/085

(57) ABSTRACT

An audio generation system is described. The audio generation system employs machine learning models to create custom background music for video data. The audio generation system receives video data as input, generates a transcript and visual scene captions for the video data, and produces a “vibe” description of the video. The vibe description, along with user inputs and preferences, is used to generate multiple music compositions. The audio generation system provides an interface for users to preview, adjust, and refine generated music compositions. Users can modify musical attributes and properties, which the system uses to regenerate compositions based on the refined vibe description. The system enables granular music generation, such as on a scene-by-scene basis, and offers features like extending, condensing, or looping specific sections of generated music, such that the generated music can be output for playback seamlessly with the video data.

### BACKGROUND

Digital videos are an increasingly popular medium for content creators to share information, entertain, and engage with diverse audiences across various platforms, from social media to professional filmmaking. To satisfy the growing demand for such video content, there exists a need for efficient, cost-effective production methods to facilitate video content generation and enhance the overall quality of their work. One crucial aspect of video editing is the incorporation of background music, which plays a significant role in setting the tone, mood, and emotional impact of the final video. Traditionally, content creators have relied on pre-existing music libraries or commissioned custom compositions to accompany videos. However, this often presents challenges in terms of finding the perfect musical match for specific visual content, navigating licensing challenges, and achieving seamless integration with a video's pacing and structure. As a result, there is a growing need to bridge the gap between video editing and music creation, allowing content creators to produce more cohesive audiovisual experiences.

### SUMMARY

Music generation techniques for video editing are described that address technical challenges facing conventional video music selection and integration methods. An audio generation system employs machine learning models to automate the creation of custom background music that aligns with the content and mood of a video. The audio generation system receives a video input, generates a transcript and visual scene captions, and uses this information to produce a “vibe” description of the video. This vibe description, along with user inputs and preferences, is then used to generate multiple music options tailored to the video content.

The audio generation system provides an interface for users to preview, adjust, and refine generated music compositions directly within a video editing timeline. Users can modify various musical attributes and their properties, which are then used by the audio system to regenerate musical compositions based on a vibe description as refined by the modified attributes and properties. The audio generation system enables granular music generation, such as on a scene-by-scene basis for video data. In some implementations, the system offers advanced features such as extending, condensing, or looping specific sections of generated music to create seamless audio for the video data. By integrating with the video editing workflow, the audio generation system enables content creators to efficiently produce custom background music that enhances their video projects without requiring extensive musical expertise.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the music generation techniques described herein.

FIG. 2 depicts a system in an example implementation showing operation of the video generation system of FIG. 1 in greater detail as generating video content based on text input and parameters.

FIG. 3 depicts a system in an example implementation showing operation of a prompt generation module of the video generation system of FIG. 1 in greater detail as generating prompt based on input a transcript segment and a caption for at least one selected scene, and optionally a vibe summary.

FIG. 4 depicts a system in an example implementation as including a user interface displaying a vibe description generated by the audio generation system of FIG. 1.

FIG. 5 depicts a system in an example implementation as including a user interface displaying modifications to the vibe description generated by the audio generation system of FIG. 1.

FIG. 6 depicts a system in an example implementation showing operation of the audio generation system of FIG. 1 in greater detail as creating generated audio for video data.

FIG. 7 depicts a system in an example implementation showing operation of the prompt generation module of the audio generation system of FIG. 1 in greater detail as generating a prompt based on vibe properties for a selected scene of video data.

FIG. 8 depicts a system in an example implementation as including a user interface displaying video data along with different instances of generated audio created by the audio generation system of FIG. 1.

FIG. 9 depicts a system in an example implementation as including a user interface displaying modifications to the vibe properties from which a selected music representation was generated by the audio generation system of FIG. 1.

FIG. 10 illustrates an example system that depicts a user interface with controls for switching between different versions of audio generated by the audio generation system of FIG. 1 based on input to the vibe description window.

FIG. 11 depicts a procedure in an example implementation of vibe-guided music generation for video data.

FIG. 12 depicts a procedure in an example implementation of generating and refining music for video data.

FIG. 13 illustrates an example system including various components of an example device that can be implemented as any type of computing device as described and/or utilize with reference to the previous figures to implement the techniques described herein.

### DETAILED DESCRIPTION

### Overview

Conventionally, adding background music to video editing projects presents significant challenges for content creators, particularly those who lack expertise in music composition or editing. This process is often tedious, time-consuming, and prone to suboptimal results. Content creators typically rely on pre-existing music libraries or commissioned compositions, which frequently fall short of precisely matching the desired mood, pacing, and emotional impact for specific video content. The limitations of these conventional approaches lead to numerous difficulties in finding suitable musical accompaniment, navigating complex licensing challenges, and achieving seamless integration with a video's structure and timing.

The importance of background music in video content cannot be overstated, as it plays a crucial role in setting the tone, mood, and overall emotional experience for video viewers. Videos lacking appropriate background music often appear less engaging and exciting compared to those with well-integrated audio accompaniment. Further, the type of music played during video playback can dramatically alter how viewers perceive and emotionally connect with the content. Existing platforms and stock libraries often fail to provide music that aligns perfectly with the specific vision of content creators. The process of searching through vast libraries of pre-existing tracks is time-intensive and frequently results in compromises, as finding the exact musical match for visual content is challenging. Content creators often have specific opinions or feelings about the type of music they want in their videos and conventional platforms are unable to consider or accommodate these precise requirements.

The manual nature of conventional music selection and integration methods also introduces a high risk of human error. Aligning audio tracks with video content, ensuring proper timing of musical cues with visual elements, and maintaining consistent audio levels throughout a video are all complex tasks that require significant attention to detail. Mistakes in these areas can immediately detract from the viewer's experience and require substantial effort to correct, further extending the already time-consuming video editing process.

To address these technical shortcomings, the described techniques introduce an audio generation system that leverages machine learning models to automate the creation of custom background music tailored to video content. The audio generation system begins by receiving input video data, which may be a rough cut of video data, a partially edited video project, or a finalized video lacking only background music. Upon receiving the video data, the audio generation system employs advanced natural language processing techniques to generate a transcript of spoken dialogue in the video data. The audio generation system additionally utilizes computer vision algorithms to analyze visual content in the video data, segmenting the video into distinct scenes and generating detailed captions for each scene.

Using this extracted information, the audio generation system creates a “vibe” description of the video. The vibe description encapsulates an overall mood, tone, and emotional context of the video content. In some implementations, generation of the vibe description for video data is further guided by user input defining a vibe summary, or an intended feeling to be invoked in a viewer during playback of the video data with accompanying music. The audio generation system outputs the vibe description via a user interface, presenting the vibe description in a format that allows content creators to easily modify various attributes and properties, which collectively define an intended vibe for music to be played back with the video data. This interactive approach enables users to refine and customize the vibe description according to their specific creative vision, offering a level of control and flexibility that is not possible via conventional music selection systems.

Based on the vibe description and optional user modifications, the audio generation system employs machine learning models to generate multiple distinct music compositions. Each music composition is tailored to align with the video's content, mood, and structure while offering unique variations to help content creators ideate and identify the appropriate musical composition for their video data. This approach provides content creators with a range of musical options, each custom-generated to complement their specific video content while being constrained by the attributes and properties of the vibe description.

The audio generation system further enhances the user experience by displaying representations of these generated music compositions directly within a user interface that outputs playback of the video data, (e.g., in a user interface that includes a video editing timeline). This integration allows content creators to preview how each musical option aligns with their video content in real-time. Users are provided with controls that enable them to easily adjust various attributes and parameters that guided generation of a selected musical composition, such as genre, instrumentation, energy level, tempo, volume, and so forth. In response to receiving user input refining vibe description parameters, the audio generation system is configured to regenerate a selected music composition based on the refined parameters.

Advantageously, the audio generation system enables generation of music for video data on a granular level, thus allowing for scene-by-scene audio customization within a single video. This level of precision in music generation and synchronization is not feasible with conventional music selection systems and techniques. As yet a further advantage not realized by conventional systems, the audio generation system provides advanced features such as the ability to extend, condense, or loop specific sections of generated music, ensuring seamless audio integration throughout video playback.

The audio generation system enables output of the video data (e.g., for playback by one or more viewers) with a selected music composition, providing a cohesive and professionally scored final product. This end-to-end solution significantly streamlines the video editing workflow relative to conventional approaches, reducing the time and effort required to find and integrate background music that is tailored to video data.

The described techniques thus offer substantial technical advantages over conventional systems. By automating the music creation process and tailoring it specifically to video content, the audio generation system eliminates the need for extensive musical expertise or time-consuming manual searches through music libraries. The machine learning-driven approach employed by the audio generation system ensures that generated music not only matches the overall mood of the video but also adapts to specific scenes and transitions, providing a level of customization and coherence that is not possible via conventional systems. Furthermore, the audio generation system's ability to generate multiple variations and allow for real-time adjustments fosters creativity and experimentation, enabling content creators to explore diverse musical options without the need to search for, identify, and license audio from multiple external music sources.

Further discussion of these and other examples is included in the following discussion and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks (e.g., transformer models), convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also the complexity and scale of the neural networks, which may include billions or even trillions of parameters.

Large language models are configurable to perform a wide range of language-related tasks without being explicitly programmed for each one. Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Digital Audio Generation Environment

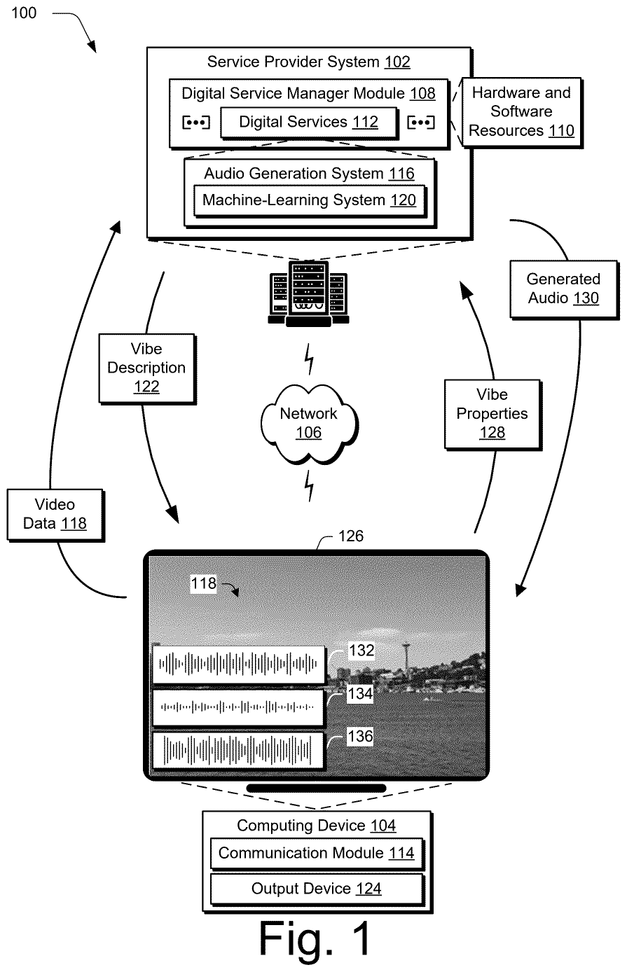

FIG. 1 is an illustration of a digital medium environment 100 in an example implementation that is operable to employ the music generation techniques described herein. The illustrated environment 100 includes a service provider system 102 and a computing device 104 that are communicatively coupled, one to another, via a network 106. Computing devices are configurable in a variety of ways.

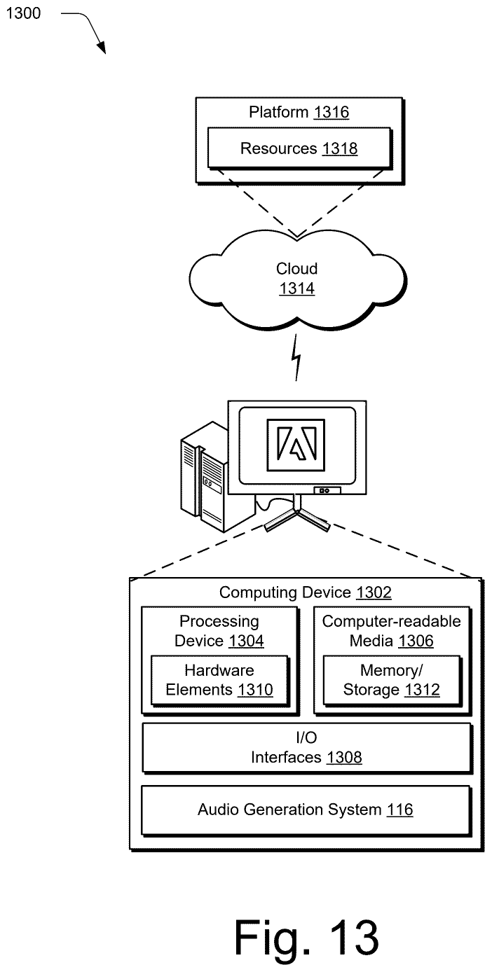

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 13.

The service provider system 102 includes a digital service manager module 108 that is implemented using hardware and software resources 110 (e.g., a processing device and computer-readable storage medium) in support of one or more digital services 112. Digital services 112 are made available, remotely, via the network 106 to computing devices (e.g., computing device 104).

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

In the illustrated example, the digital services 112 are utilized to implement an audio generation system 116, although implementation of the audio generation system 116 locally by the computing device 104 is also supported. The audio generation system 116 is configured to receive video data 118 and process the video data 118 by a machine-learning system 120 to generate a vibe description 122 for the video data 118 (e.g., using generative AI). As described herein, the video data 118 is representative of a combination of visual and audio content that is perceivable by a viewer during playback, including image data, spoken dialogue, sound effects, and environmental noise. Video data 118 thus encompasses audio/visual elements of a video, excluding background music, and may be received by the audio generation system 116 in various stages of editing, from raw footage to a nearly complete video project lacking only musical accompaniment.

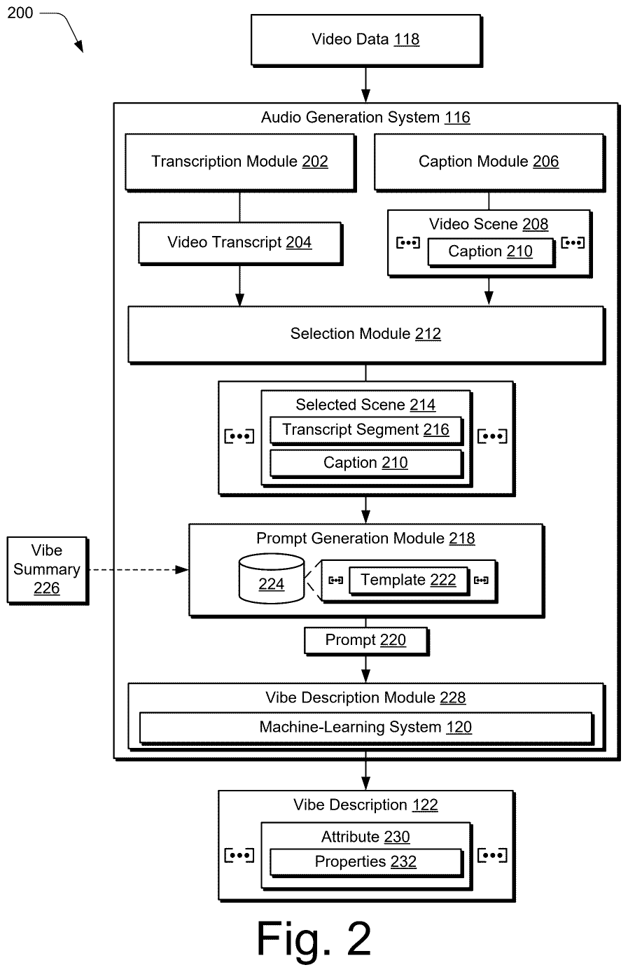

As described herein, the vibe description 122 refers to a data structure or representation that encapsulates the overall mood, tone, emotional context, and stylistic attributes of music to be played back with the video data 118. As described in further detail below, the vibe description 122 is structured to include multiple categories that define different attributes of music to be output during playback of the video data 118, with each category defined by one or more parameters. Example categories include, but are not limited to, genre, instruments, mood, theme, energy level, tempo, and volume. In implementations, the vibe description 122 is generated by the audio generation system 116 based on information derived from video data 118 (e.g., transcript information and visual scene captions) and optionally based on user input (e.g., user input at the computing device 104). Generation of the vibe description 122 is described in further detail below with respect to FIG. 2.

The vibe description 122, upon receipt by the computing device 104, is configured for output via output device 124. In implementations, the output device 124 is representative of one or more hardware components such as a display screen, monitor, television, projector, or other visual output hardware capable of presenting video content (e.g., via a user interface 126). In some implementations, the output device 124 is integrated into computing device 104 (e.g., a laptop or smartphone display). Alternatively or additionally, the output device 124 is implemented as a separate peripheral device connected to the computing device 104.

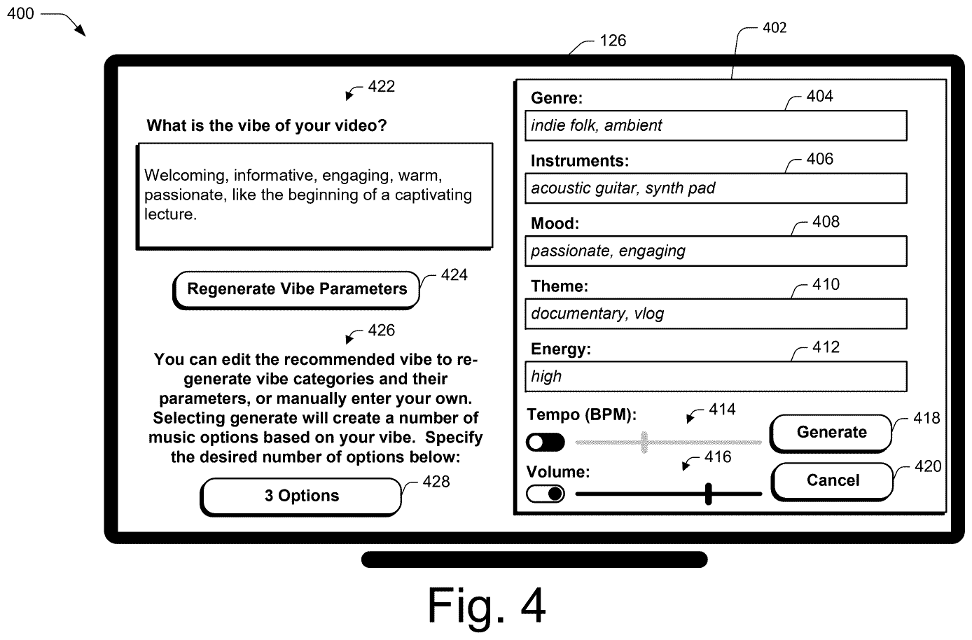

As described in further detail below with respect to the illustrated examples of FIGS. 4, 5, 8, 9, and 10, the output device 124 is configured to display the vibe description 122 via the user interface 126, which enables a user of the computing device 104 to modify one or more properties of attributes that collectively define a “vibe” for a musical composition to accompany playback of the video data 118. Via interaction with controls and fields presented via the user interface 126, a user of the computing device 104 is able to precisely define a mood, emotion, sentiment, tone, feeling, etc. that is desired to be evoked by the collective playback of video data 118 and accompanying audio (e.g., background music). Collectively, these parameters for the desired vibe (i.e., mood, emotion, sentiment, tone, feeling, etc. that is desired to be evoked by the collective playback of video data 118 and accompanying audio) are represented as vibe properties 128.

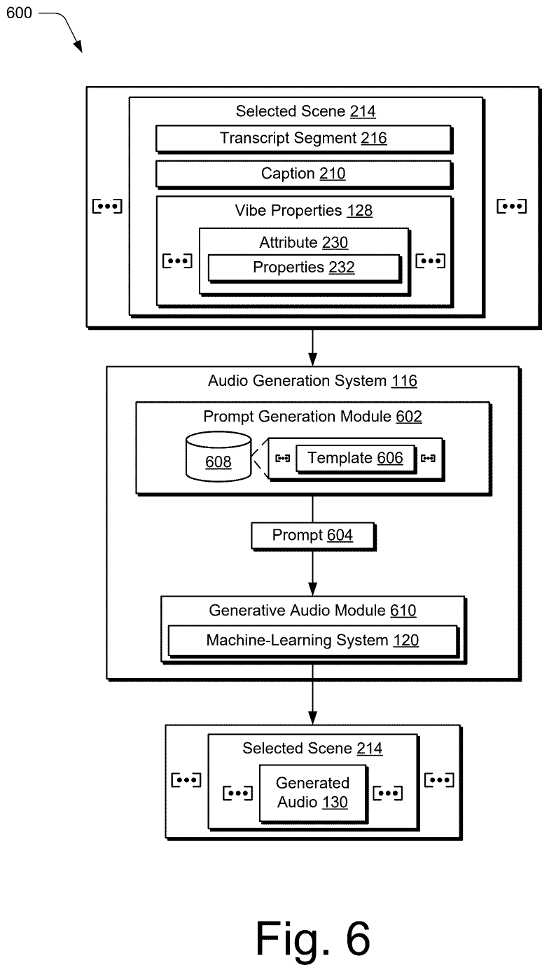

The vibe properties 128 are transmitted to the audio generation system 116, which leverages the machine-learning system 120 to synthesize (e.g., create) generated audio 130 for the video data 118. A description of the audio generation system 116 creating the generated audio 130 is provided in further detail below with respect to FIG. 6. In implementations, the audio generation system 116 tasks the machine-learning system 120 with generating multiple different musical compositions based on the vibe properties 128, such that the audio generation system 116 generates different audio options for a defined vibe. The audio generation system 116 communicates the generated audio 130 to the computing device 104 for output (e.g., playback). In the illustrated example of FIG. 1, the generated audio 130 is representative of three different musical compositions generated based on the vibe properties 128.

Upon receipt of the generated audio 130, the user interface 126 is configured to output a representation of each different musical composition included in the generated audio 130. For instance, in the illustrated example of FIG. 1, user interface 126 is depicted as outputting playback of the video data 118 as well as displaying a first music representation 132, a second music representation 134, and a third music representation 136. The first music representation 132, the second music representation 134, and the third music representation 136 are each depicted as waveforms of respective musical compositions generated by the audio generation system 116, and are individually selectable via user input at computing device 104 to preview how playback of the video data 118 will be perceived when accompanied by generated audio 130.

In some implementations, the first music representation 132, the second music representation 134, and the third music representation 136 are output in the user interface 126 as part of a timeline video editing interface, such that the respective representations of generated audio 130 are time-aligned with a playback timeline representation of the video data 118. As described in further detail below, the user interface 126 includes controls and input fields that enable a user to modify aspects involved in creation of the vibe description 122, the vibe properties 128, the generated audio 130, and iterations thereof, in an ongoing manner, enabling for generation of music for video data 118 on a granular level (e.g., allowing for scene-by-scene customization of generated audio 130). For a further description of the audio generation system 116 generating a vibe description 122 based on video data 118, consider FIG. 2.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Video Data Vibe Description Generation

FIG. 2 depicts a system 200 in an example implementation showing operation of the audio generation system 116 of FIG. 1 in greater detail as generating a vibe description 122 based on video data 118. In the illustrated example of FIG. 2, the audio generation system 116 is depicted as receiving video data 118 (e.g., from computing device 104). The audio generation system 116 includes several interconnected modules that process the video data 118 in a sequential manner. Initially, the video data 118 is processed by a transcription module 202, which represents functionality of the audio generation system 116 to generate a video transcript 204 that captures spoken dialogue in the video data 118.

Initially, the transcription module 202 cleans and enhances the input audio from the video data 118. This cleaning and enhancement involves reducing background noise, normalizing volume levels, and applying audio filters to improve overall sound quality. Such enhancements help isolate speech content from other audio elements present in the video data 118.

Following audio preprocessing, the transcription module 202 extracts key features from the sound using known signal processing techniques. These features may include frequency patterns, spectral characteristics, and phonetic markers that are crucial for speech recognition. The feature extraction process may employ techniques such as Mel-frequency cepstral coefficients (MFCCs) or perceptual linear prediction (PLP) to represent the audio in a format suitable for machine learning analysis.

The extracted features are then analyzed by a machine learning model or speech recognition engine included in the machine-learning system 120. For instance, extracted features are analyzed by a deep neural network, such as a recurrent neural network (RNN) or transformer architecture, trained on vast amounts of diverse speech data. The model implemented by the transcription module 202 is thus representative of a model included in the machine-learning system 120 and designed to recognize individual phonemes and words from the audio features, leveraging training to handle various accents, speaking styles, and audio conditions.

Alternatively, in some implementations the transcription module 202 generates video transcript 204 independent of (e.g., without) extracting features prior to analysis by the machine-learning system 120. For instance, the transcription module 202 generates video transcript 204 by inputting the video data 118 to a machine learning model (e.g., a neural network) included in the machine-learning system 120 that is configured to generate the video transcript 204 based on the video data 118 independent of preprocessing the video data 118.

To improve accuracy, in some implementations the transcription module 202 applies language models of the machine-learning system 120 that consider context, grammar, and common phrase structures. Such models help disambiguate similar-sounding words and correct potential errors based on linguistic probabilities (e.g., employing techniques such as n-gram models or more advanced neural language models to refine the initial speech recognition output).

Finally, the transcription module 202 assembles the recognized words into a coherent text output, forming the video transcript 204. This process may involve additional formatting and punctuation adjustments to enhance readability. The module may also include speaker standardization capabilities to differentiate between multiple speakers in the video data 118, and may timestamp the transcript to align text with specific points in the video timeline.

In implementations, the transcription module 202 processes audio included in the video data 118 through multiple stages to produce the video transcript 204 in a defined format (e.g., a JavaScript Object Notation (JSON) format or other human-readable text format that includes a transcription of each spoken word detected in the video along with start and end times in the video data 118 at which the spoken word is heard). In implementations, the video transcript 204 further includes sentence-level timings and full punctuation for each sentence, as well as identifying information for a source of the spoken words.

The audio generation system 116 further includes a caption module 206, which represents functionality of the audio generation system 116 to generate visual scene captions for the video data 118. The caption module 206 processes visual content of the video data 118 to identify different video scenes 208 in the video data 118 and produce, for each video scene 208, a caption 210 that describes visual elements present in the video scene 208.

To do so, the caption module 206 segments the video data 118 into distinct visual scenes 208. This segmentation process employs a pipeline that uniformly samples frames from the video data 118 at a defined rate (e.g., two frames per second). For each sampled frame, the caption module 206 generates an embedding (e.g., using the Contrastive Language-Image Pre-Training (CLIP) model or a similar model included in the machine-learning system 120).

The caption module 206 then clusters the frame embeddings using the Affinity Propagation algorithm. Based on this clustering, the caption module 206 merges sample frames to define coherent video scenes 208. This approach ensures that visually similar content is grouped together, creating meaningful scene divisions within the video data 118.

Following scene segmentation, the caption module 206 proceeds to the second stage of processing, which involves generating a concise description for each identified scene. To do so, the caption module 206 selects at least one frame (e.g., the middle frame) of each scene as a representative image. This middle frame is then processed using a Large Language and Vision Assistant (LLAVA) model, trained large multimodal model, or other vision-language model functionality included in the machine-learning system 120.

The LLAVA model analyzes the selected frame and generates a concise textual description of its contents. This description may include information about the setting, actions, objects, and other visually salient elements present in the scene. The caption module 206's use of a vision-language model ensures that the generated captions 210 are accurate, detailed, and contextually relevant to the visual content of each scene.

In implementations, output of the caption module 206 is structured in a JSON format, providing a standardized and easily divisible representation of the scene information. In such implementations, the JSON output includes an array of objects (e.g., one object for each video scene 208), where an individual object includes data describing the generated scene description, as well as the start and end times of that scene within the video data 118. This temporal information allows for precise alignment of the captions 210 with the corresponding video segments and the transcript generated by the transcription module 202.

By employing this sophisticated two-stage process of scene segmentation and description generation, the caption module 206 produces a comprehensive set of captions 210 that effectively capture the visual narrative of the video data 118. These captions provide crucial context for understanding the visual content of the video, complementing the audio transcript, and contributing to the overall vibe description 122 generation process. In some implementations, the transcription module 202 and the caption module 206 are configured to perform their respective functionality in parallel, thus expediting the process of generating the vibe description 122.

The audio generation system 116 further includes a selection module 212, which represents functionality to enable user interaction with the processed video data 118 through the user interface 126. This module allows users to define specific portions of the video data 118 for which they want to generate a vibe description 122, thus providing a more granular and customized approach to music generation.

The selection module 212 is designed to allow users to interactively select one or more video scenes 208 for further processing. This selection process results in the designation of at least one selected scene 214, which serves as the focus for subsequent vibe description generation. The flexibility of the selection module 212 allows for various scopes of selection, ranging from a single video scene 208 to multiple scenes, or even the entirety of the video data 118.

Once a user defines a selected scene 214 through the user interface 126, the selection module 212 identifies the start and end times associated with the selected scene 214. Using these temporal markers, the selection module 212 extracts the corresponding portion of the video transcript 204 generated by the transcription module 202. This extracted portion is represented as the transcript segment 216 in FIG. 2, ensuring that relevant spoken content is considered for vibe description generation.

Simultaneously, the selection module 212 retrieves the appropriate caption 210 for each video scene 208 included within the selected scene 214. This process leverages the JSON-formatted output from the caption module 206, which includes start and end times for each scene description. By aligning these timestamps with the selected scene 214, the module ensures that the visual context is accurately represented.

The selection module 212 then compiles the transcript segment 216 and the corresponding captions 210 for all video scenes 208 within the selected scene 214. This compiled information is packaged and forwarded to a prompt generation module 218, providing a comprehensive representation of both the audio and visual elements of the selected portion of the video data 118.

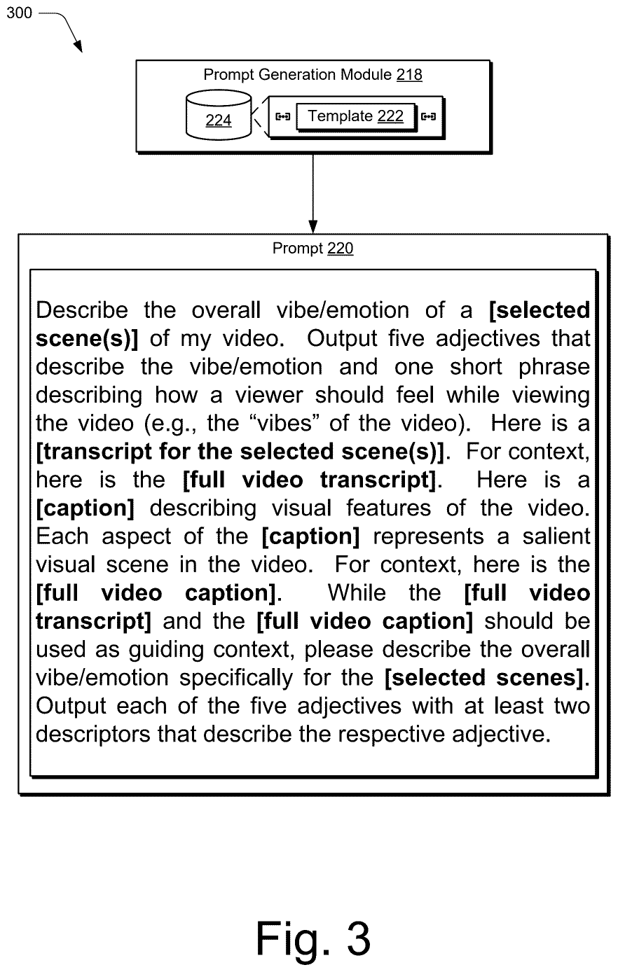

The prompt generation module 218 represents functionality of the audio generation system 116 to generate a prompt 220 to initiate generation of a vibe description 122 for the selected scene 214 using one or more machine learning models. The prompt generation module 218 is configured to generate the prompt 220 in a variety of ways, including use of one or more templates 222 (illustrated as stored in a storage device 224) that are “filled in” by the prompt generation module 218 (e.g., using natural language processing). In some implementations, generation of the prompt 220 is further guided by user input describing a desired vibe to be evoked by the generated audio 130, depicted in the illustrated example of FIG. 2 as vibe summary 226. Receipt of the vibe summary 226 is optional, as indicated by the dashed arrow connecting the vibe summary 226 to the prompt generation module 218. Thus, in some implementations the audio generation system 116 is configured to generate the prompt 220 automatically and independent of (e.g., without) user input. For a further description of a prompt 220 generated by the prompt generation module 218, consider the following example of FIG. 3.

FIG. 3 depicts a system 300 in an example implementation showing operation of the prompt generation module 218 in greater detail as generating prompt 220 based on input a transcript segment 216 and a caption 210 for at least one selected scene 214, and optionally a vibe summary 226.

In order to aggregate the information represented by the transcript segment 216, the caption 210, and optionally the vibe summary 226, a template 222 configured to employ text is used. In the illustrated example, the prompt 220 represents text of a template that is populated based on the transcript segment 216 and the caption 210. For instance, in the illustrated example of FIG. 3, the template is used to generate a prompt that instructs the machine-learning system 120 to “Describe the overall vibe/emotion of a [selected scene(s)] of my video.” The prompt 220 further guides a manner in which the machine-learning system 120 is instructed to generate the vibe description 122. For instance, the prompt 220 instructs the machine-learning system 120 to “Output five adjectives that describe the vibe/emotion and one short phrase describing how a viewer should feel while viewing the video (e.g., the “vibes” of the video). Here is a [transcript for the selected scene(s)]. For context, here is the [full video transcript]. Here is a [caption] describing visual features of the video. Each aspect of the [caption] represents a salient visual scene in the video. For context, here is the [full video caption]. While the [full video transcript] and the [full video caption] should be used as guiding context, please describe the overall vibe/emotion specifically for the [selected scenes]. Output each of the five adjectives with at least two descriptors that describe the respective adjective.”

The prompt generation module 218 is thus configured to generate the prompt 220 by replacing portions of the template 222 represented by bracketed bold font based on information included in the transcript segment 216 and the caption 210. For instance, the sentence “Here is a transcript for the selected scene(s)” in the template 222 might be modified to “Here is a transcript for the opening scene: ‘Hello, my name is Ailie.’” Thus, the prompt generation module 218 is configured to modify the template 222 using context-specific information, such that the prompt 220 is adapted for video-specific information. In addition to generating the prompt 220 based on the transcript segment 216 and the caption 210 for the selected scene 214, the prompt generation module 218 generates the prompt 220 with additional context from the video transcript 204 and captions 210 for each video scene 208 in the video data 118, thus providing the machine-learning system 120 with context about what is conveyed by the video data 118 outside the selected scene 214.

Although a specific example template is illustrated and described with respect to generating prompt 220, the described techniques are not so limited and the prompt generation module 218 is configured to leverage a variety of different templates 222. For instance, individual templates 222 are configurable in various ways, offering flexibility and customization in the audio generation process, such as to accommodate a user-specified objective, as represented by the vibe summary 226. As a specific example, in implementations where a user-provided vibe summary 226 is received by the prompt generation module 218, the prompt generation module 218 updates the prompt in FIG. 3 by replacing the second sentence with “Output five adjectives that describe the vibe/emotion, with the understanding that the [vibe summary] is how a viewer should feel while viewing the video.”

In some implementations, templates 222 are dynamically generated or modified (e.g., by the audio generation system 116) based on the specific transcript segment 216, caption 210, or vibe summary 226 received, or the prompt generation module 218 is configured to select from multiple templates 222 based on such input data, choosing the most appropriate template for a given combination of a transcript segment 216, one or more caption 210, and a vibe summary 226. This approach allows for even greater customization of the prompt 220 generated for the machine-learning system 120, enhancing the audio generation system 116's ability to produce generated audio 130 that is tailored based on the video data 118.

Returning to FIG. 2, the prompt 220 is provided as input to a vibe description module 228, which implements at least one machine-learning system 120 to generate a vibe description 122 based on the prompt 220. The vibe description 122 includes a plurality of attributes 230, which are each defined by at least one property 232. In implementations, each of the attributes 230 correspond to one of the “five adjectives” referenced by the example prompt 220 depicted in FIG. 3. The properties 232 correspond to the “descriptors” referenced by the example prompt 220 of FIG. 3. In implementations, the audio generation system 116 is configured to output the vibe description 122 to the computing device 104 (e.g., for display via the user interface 126).

FIG. 4 depicts a system 400 in an example implementation as including a user interface displaying a vibe description 122 generated by the audio generation system 116. Specifically, in the illustrated example of FIG. 4, user interface 126 is depicted as displaying a vibe description window 402 that contains multiple input fields for defining parameters of the vibe properties 128 that serve as a basis for creating generated audio 130 for the video data 118.

Specifically, the illustrated example includes a genre input field 404 for specifying musical genres, an instruments input field 406 for selecting musical instruments, a mood input field 408 for indicating desired emotional qualities, a theme input field 410 for selecting thematic elements, and an energy input field 412 for setting the energy level of the music. In the illustrated example of FIG. 4, different input fields are depicted as being prepopulated with information included in the vibe description 122 generated by the audio generation system 116. For instance, each input field corresponds to an attribute 230 included in the vibe description 122, such that the vibe description window 402 is generated based on the vibe description 122 including a genre attribute, an instruments attribute, a mood attribute, a theme attribute, and an energy attribute.

Respective properties 232 of each attribute 230 as included in the vibe description 122 are used to populate the corresponding field, such that FIG. 4 depicts an example scenario where the genre attribute is characterized by “indie folk” and “ambient” properties 232, the instruments attribute is characterized by “acoustic guitar” and “synth pad” properties 232, the mood attribute is characterized by “passionate” and “engaging” properties 232, the theme attribute is characterized by “documentary” and “vlog” properties 232, and the energy attribute is characterized by a “high” property 232. Each property included in an input field for a corresponding attribute is modifiable via user input, as described in further detail below.

In addition to the above-noted attributes, the vibe description window 402 additionally includes a display of a tempo control 414 and a volume control 416, which are representative of tempo (e.g., beats per minute) and volume attributes 230 in the vibe description 122, respectively. The tempo control 414 is depicted as including a toggle control that is configured to receive input indicating whether or not the tempo attribute should be include in the vibe properties 128. In the illustrated example of FIG. 4, the toggle control of the tempo control 414 is set to off, such that the tempo attribute is excluded from the vibe properties 128 (e.g., indicated by the grayed-out slider bar of the tempo control 414). Alternatively, in response to the toggle control of the tempo control 414 being activated (e.g., set to on), the slider bar of the tempo control 414 is configured to receive input defining a tempo for the vibe properties 128 within a constrained range (e.g., 41 to 180 beats per minute).

In a similar manner, the volume control 416 is depicted as including a toggle control that is configured to receive input indicating whether the volume attribute should be included in the vibe properties 128. In the illustrated example of FIG. 4, the toggle control of the volume control 416 is set to on, such that the volume attribute is included in the vibe properties 128. Input to the slider bar of the volume control 416 is configured to receive input defining a volume for the generated audio 130 within a constrained range (e.g., 1 to 100).

The vibe description window 402 further includes a generate button 418 and a cancel button 420 to allow users to initiate or cancel the music generation process, respectively. In the illustrated example of FIG. 4, the vibe description window 402 is displayed in the user interface 126 with a vibe summary field 422 that displays text describing the desired vibe of the video (e.g., the vibe summary 226), providing users with a concise overview of the attributes 230 and their properties 232 as included in the vibe description 122. Advantageously, this enables users to refine information considered by the audio generation system 116 when generating the vibe description 122 and offers the option to regenerate the vibe description 122 based on inputs to the vibe description window 402, the vibe summary field 422, or combinations thereof. This ability to regenerate the vibe description 122 is represented by the inclusion of a regenerate button 424, which is selectable via user input instruct the audio generation system 116 to generate a new vibe description 122 based on modifications to the input fields depicted in the illustrated example of FIG. 4. This process of regenerating the vibe description 122 for video data 118 is repeatable for any number of iterations, until a user of the computing device 104 is satisfied that the vibe description 122 accurately summarizes an intended vibe to be experienced by a viewer during playback of the video data 118 with generated audio 130.

The user interface 126 further includes a display of instructions 426, which guide users on how to edit and regenerate vibe categories and parameters. Specifically, the instructions 426 state that “You can edit the recommended vibe to re-generate vibe categories and their parameters, or manually enter your own. Selecting generate will create a number of music options based on your vibe. Specify the desired number of options below.” To enable specification of the number of different options to be generated based on the vibe description 122, the user interface 126 includes options selector 428, which is configured to receive user input specifying a number of different music compositions to be included in the generated audio 130, providing flexibility in the creative process. This comprehensive interface layout presents these elements in an organized manner that facilitates user interaction with the music generation system, allowing for detailed customization of the audio to be generated for the video data.

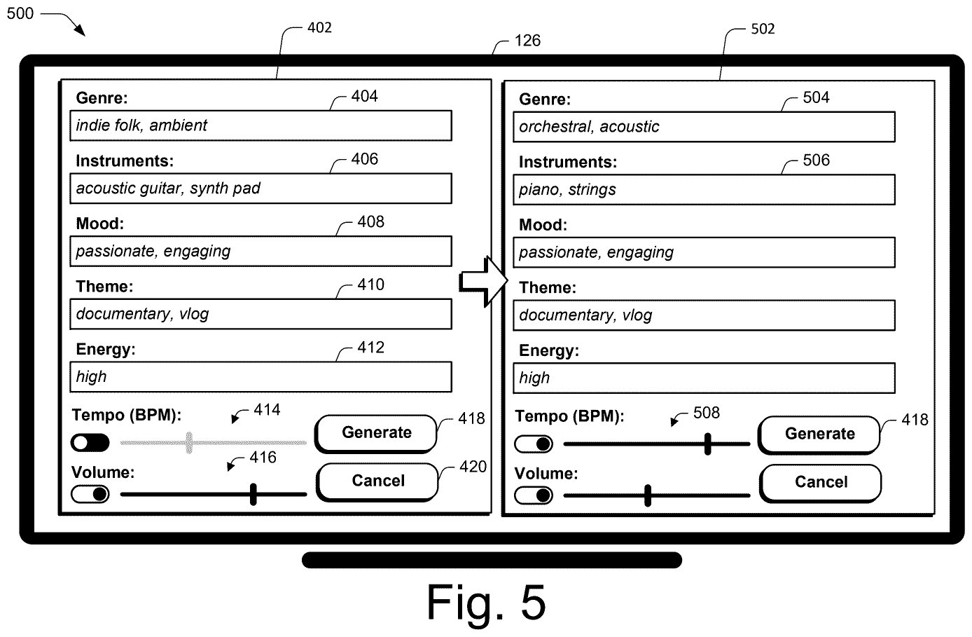

FIG. 5 depicts a system 500 in an example implementation as including a user interface 126 displaying modifications to the vibe description 122 generated by the audio generation system 116. Specifically, in the illustrated example of FIG. 5, user interface 126 is depicted as displaying two vibe description windows: the original vibe description window 402 and a modified vibe description window 502. As described above with respect to FIG. 4, the modified vibe description window 502 is representative of an updated instance of vibe description window 402, which includes multiple input fields for defining parameters of the vibe properties 128 that serve as a basis for creating generated audio 130 for the video data 118.

The modified vibe description window 502 displays changes made to several attributes and their properties. For instance, in the vibe description window 502, the genre input field 504 displays “orchestral” and “acoustic” as the properties for the genre attribute, replacing the “indie folk” and “ambient” properties shown in the genre input field 404 of window 402. Similarly, the instruments input field 506 in vibe description window 502 displays “piano” and “strings” as the properties for the instruments attribute, replacing the “acoustic guitar” and “synth pad” properties displayed in the instruments input field 406 of vibe description window 402.

Additionally, vibe description window 502 is depicted as including a modified tempo control 508, which represents a changed instance of tempo control 414. In contrast to the tempo control 414, which was previously inactive, the tempo control 508 is now activated. This activation indicates that the modified vibe properties 128 will include a more upbeat tempo relative to a tempo attribute 230 as was originally included in the vibe description 122 generated by the audio generation system 116 (e.g., as represented by the modified slider position of tempo control 508).

In this manner, the vibe description window 402 is representative of a display of information for a vibe description 122 generated by the audio generation system 116, while the vibe description window 502 is representative of a display of information that defines the vibe properties 128, which instruct the audio generation system 116 to create generated audio 130 for the video data 118.

In response to receiving input at the generate button 418, the vibe description 122 as generated by the audio generation system 116—and optionally modified via user input to one or more of the vibe description window 402, vibe summary field 422, regenerate button 424, or options selector 428—is communicated to the audio generation system 116 as vibe properties 128. For a further description of the audio generation system 116 generating generated audio 130 based on the vibe properties 128, consider FIG. 6.

FIG. 6 depicts a system 600 in an example implementation showing operation of the audio generation system 116 in greater detail as creating generated audio 130 for video data 118. In the illustrated example of FIG. 6, the audio generation system 116 is depicted as receiving a selected scene 214 (e.g., responsive to user input at computing device 104 selecting generate button 418). As described above with respect to FIG. 2, the selected scene 214 is received with a transcript segment 216 and a caption 210 for at least one video scene 208 included in the selected scene 214. The selected scene 214 further includes the vibe properties 128, which are defined by at least one attribute 230, each of which are defined by at least one property 232.

The audio generation system 116 includes interconnected modules that process data for the selected scene 214 in a sequential manner to produce the generated audio 130 for the video data 118. To begin, the selected scene 214 is processed by a prompt generation module 602, which represents functionality of the audio generation system 116 to generate a prompt 604 to initiate creation of the generated audio 130 for the selected scene 214 using one or more machine learning models.

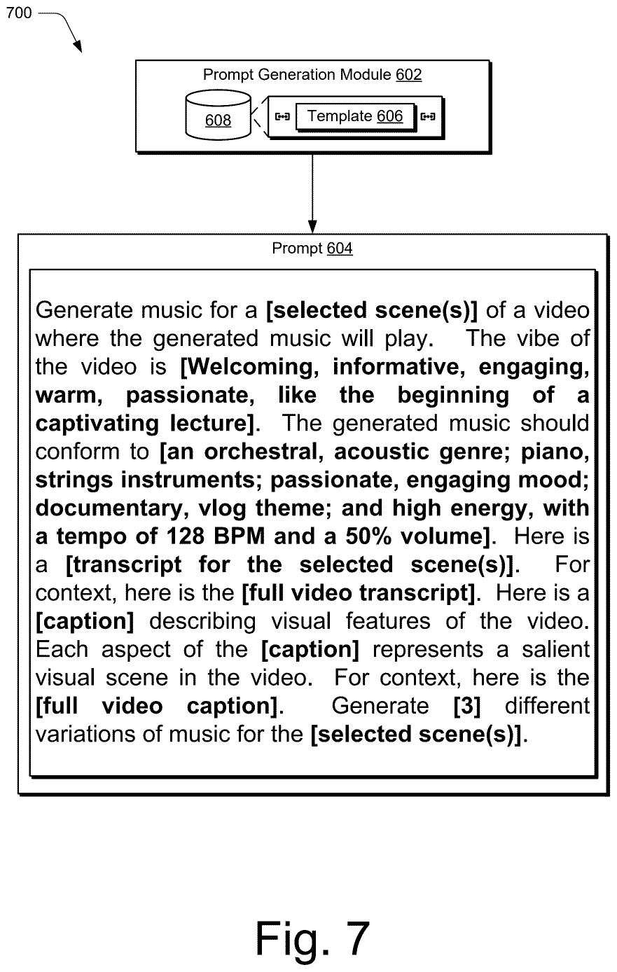

The prompt generation module 602 is configured to generate the prompt 604 in a variety of ways, including use of one or more templates 606 (illustrated as stored in a storage device 608) that are “filled in” by the prompt generation module 602 (e.g., using natural language processing). In some implementations, generation of the prompt 604 is guided by the vibe properties 128 included in the selected scene 214, which defines attributes 230 and properties 232 that characterize a desired vibe for the generated audio 130. For a further description that includes an example of the prompt 604, consider FIG. 7.

FIG. 7 depicts a system 700 in an example implementation showing operation of the prompt generation module 602 in greater detail as generating prompt 604 based on vibe properties 128 for a selected scene 214 of video data 118. In order to aggregate the information represented by the vibe properties 128, a template 606 configured to employ text is used. In the illustrated example, the prompt 604 represents text of a template that is populated based on the vibe properties 128, the transcript segment 216 and the caption 210 for the selected scene 214.

For instance, in the illustrated example of FIG. 7, the template 606 is used to generate a prompt that instructs the machine-learning system 120 to “Generate music for a [selected scene(s)] of a video where the generated music will play. The vibe of the video is [Welcoming, informative, engaging, warm, passionate, like the beginning of a captivating lecture]. The generated music should conform to [an orchestral, acoustic genre; piano, strings instruments; passionate, engaging mood; documentary, vlog theme; and high energy, with a tempo of 128 BPM and a 50% volume]. Here is a [transcript for the selected scene(s)]. For context, here is the [full video transcript]. Here is a [caption] describing visual features of the video. Each aspect of the [caption] represents a salient visual scene in the video. For context, here is the [full video caption]. Generate [3] different variations of music for the [selected scene(s)].”

The prompt generation module 602 is thus configured to generate the prompt 604 by replacing portions of the template 606 represented by bracketed bold font based on information included in the vibe properties 128, the transcript segment 216, and the caption 210. In addition to generating the prompt 604 based on the vibe properties 128, the transcript segment 216, and the caption 210 for the selected scene 214, the prompt generation module 602 is configured to generate the prompt 604 with additional context from the video transcript 204 and captions 210 for each video scene 208 in the video data 118, thus providing the machine-learning system 120 with context about what is conveyed by the video data 118 outside the selected scene 214.

Although a specific example template is illustrated and described with respect to generating prompt 604, the described techniques are not so limited and the prompt generation module 602 is configured to leverage a variety of different templates 606. For instance, individual templates 606 are configurable in various ways, offering flexibility and customization in the audio generation process.

In some implementations, templates 606 are dynamically generated or modified (e.g., by the audio generation system 116) based on the specific vibe properties 128, transcript segment 216, or caption 210 associated with the selected scene 214. Alternatively or additionally, the prompt generation module 602 is configured to select from multiple templates 606 based on such input data, choosing the most appropriate template for a given combination of a vibe properties 128, transcript segment 216, and caption 210. This approach allows for even greater customization of the prompt 604 generated for the machine-learning system 120, enhancing the audio generation system 116's ability to produce generated audio 130 that is tailored based on the selected scene 214 of the video data 118.

Returning to FIG. 6, the prompt 604 is provided as input to a generative audio module 610, which implements at least one machine-learning system 120 to generate audio 130 based on the prompt 604. The generative audio module 610 represents functionality of the audio generation system 116 to create musical compositions that align with the vibe properties 128 for the selected scene 214.

The generative audio module 610 employs advanced machine learning techniques to interpret the prompt 604 and generate appropriate musical composition. The generative audio module 610 is configured to utilize diverse types of neural networks, such as transformers or generative adversarial networks (GANs), specifically trained on vast datasets of musical compositions across different genres, instruments, styles, and so forth. The machine learning system 120 leveraged by the generative audio module 610 is designed to understand the nuanced relationships between textual descriptions of music (as provided in the prompt 604) and actual acoustic characteristics that create those musical qualities.

When processing the prompt 604, the generative audio module 610 first analyzes the specified attributes (e.g., genre, instruments, mood, theme, and energy level). The generative audio module 610 then synthesizes these elements to create a coherent musical composition that embodies the desired characteristics. In implementations, the generative audio module 610 is configured to generate multiple layers of audio, including melodic lines, harmonic progressions, rhythmic patterns, and instrumental timbres, all working together to create a cohesive musical composition.

The generative audio module 610 is also configured to consider the transcript segment 216 and caption 210 information included in the prompt 604. This allows the generated audio 130 to be contextually appropriate for the content of the selected scene 214, potentially aligning musical cues with specific moments or emotional beats in the video data 118.

In some implementations, the generative audio module 610 employs a two-stage generation process. First, the generative audio module 610 creates a high-level musical structure based on the specified attributes and properties defined in the prompt 604. This high-level musical structure is then refined with detailed instrumentation, dynamics, and expressive elements to produce a polished, professional-sounding composition. In some implementations, the generative audio module 610 also applies post-processing techniques to ensure the audio quality meets professional standards, including equalization, compression, and spatial effects.

The output of the generative audio module 610 is the generated audio 130, which represents one or more musical compositions tailored to the selected scene 214 based on the vibe properties 128. In implementations, a number of different compositions included in the generated audio 130 is defined based on user input (e.g., user input at options selector 428). This generated audio 130 is then output for playback with the selected scene 214 (e.g., in the user interface 126), creating a complete audiovisual experience where the music complements and enhances audio and visuals of the video data 118.

Although not depicted in the illustrated example of FIG. 6, in some implementations the audio generation system 116 is configured to generate each musical composition included in the generated audio 130 by assigning a numerical random seed to the musical composition. This random seed is a parameter that determines where the machine-learning system 120 begins in its generation of the generated audio 130. By assigning a random seed to a musical composition, the audio generation system 116 ensures a consistent approach to generating different variations of the same musical composition in response to underlying vibe properties 128 being changed, as described in further detail below. In some implementations, the random seed is hidden from a user of the computing device 104. Alternatively, the random seed is conveyed to the user and is modifiable (e.g., via user input to the user interface 126).

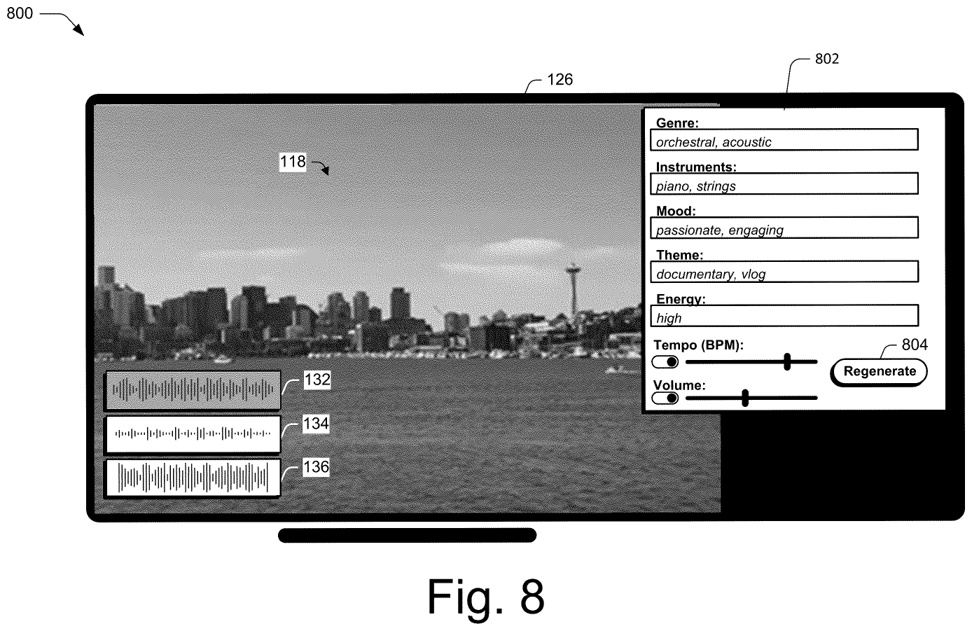

By employing this pipeline of prompt generation and audio synthesis, the audio generation system 116 enables the creation of custom background music that is specifically tailored to the content and structure of the video data 118, while conveying a desired mood, emotion, tone, and so forth. This approach offers significant advantages over conventional methods of music selection, providing content creators with music that seamlessly integrates with their video projects without requiring extensive musical expertise or time-consuming manual searches through music libraries. For a further description of how the audio generation system 116 enables users to preview how generated audio 130 aligns with the video data 118, modify individual musical compositions included in the generated audio 130, and select a musical composition to be included in a final version of the video data 118, consider FIGS. 8-10.

FIG. 8 depicts a system 800 in an example implementation as including a user interface displaying video data along with different instances of generated audio 130 created by the audio generation system 116. In the illustrated example of FIG. 8, the user interface 126 includes a display of video data 118, providing a visual representation of the content for which the generated audio 130 is being created. The user interface 126 additionally includes representations of different musical compositions generated by the audio generation system 116 based on the vibe properties 128 as part of the generated audio 130: first music representation 132, second music representation 134, and third music representation 136. Although the different music representations are arranged vertically, allowing for easy comparison and selection, the described techniques are not so limited. In some implementations, the different music representations are displayed as part of a timeline video editing interface, aligned with start and end playback positions of a selected scene 214 for which the vibe properties 128 were defined.

Each music representation is individually selectable for playback with the video data 118. This enables users of the computing device 104 to preview how the video data 118 will be perceived by viewers when accompanied by different musical compositions. By providing this preview functionality, the audio generation system 116 allows content creators to make informed decisions about which musical composition best enhances their video before finalizing the audio-visual combination (e.g., the final combination of video data 118 with one or more musical compositions of the generated audio 130).

To provide users with context during the preview process, the music representations are displayed alongside the vibe properties 128 that were used to generate each composition. For instance, in the illustrated example of FIG. 8, the first music representation 132 is selected, as indicated by the shaded coloring of first music representation 132 relative to second music representation 134 and third music representation 136. Corresponding to this selection, a vibe description window 802 is displayed with a detailed display of information describing the specific vibe properties 128 that the audio generation system 116 considered when creating the generated audio 130 for the first music representation 132.

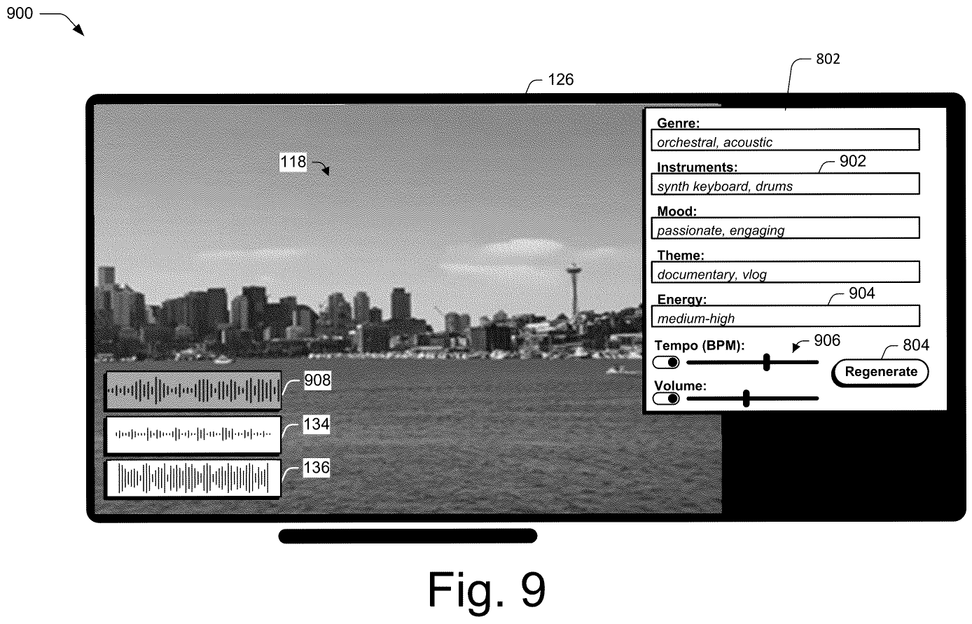

In implementations, the vibe description window 802 shares similarities with the vibe description window 402 in that it allows for comprehensive customization of the audio generation parameters. Every aspect presented in the vibe description window 802 is modifiable, enabling users to refine how the audio generation system 116 generates the first music representation 132, as described in further detail below with respect to FIG. 9. The vibe description window 802 is further depicted as including a regenerate control 804. The control 804 is selectable (e.g., via user input), allowing users to initiate the regeneration of the musical composition represented by the selected music representation. When activated, the regenerate control 804 instructs the audio generation system 116 to create an updated version of the music based on the current information displayed in the vibe description window 802. For instance, the current information displayed in the vibe description window is used to generate modified vibe properties 128, and the modified vibe properties 128 are used to generate a modified instance of the musical composition corresponding to the first music representation 132, as described with respect to FIG. 6. This enables iterative refinement of the generated audio 130, allowing users to fine-tune the music until it complements video data 118 as intended.

FIG. 9 depicts a system 900 in an example implementation as including a user interface displaying modifications to the vibe properties 128 from which a selected music representation was generated by the audio generation system 116. Specifically, in the illustrated example of FIG. 9, user interface 126 is depicted as displaying video data 118 along with a vibe description window 802 that contains multiple input fields for defining parameters of the vibe properties 128 that serve as a basis for creating generated audio 130 for the video data 118.

Relative to FIG. 8, the vibe description window 802 as depicted in FIG. 9 displays changes made to several attributes and their properties. For instance, the instruments field 902 now shows “synth keyboard” and “drums” as properties for the instruments attribute, replacing the “piano” and “strings” properties as displayed in FIG. 8. Similarly, the energy field 904 now displays “medium-high” as the property for the energy attribute, modifying the “high” property displayed in FIG. 8.

Additionally, FIG. 9 depicts a modified tempo control 906, which represents a changed instance of the tempo control from that depicted in FIG. 8. The modified position of the tempo control 906 indicates a decrease in tempo relative to the original setting, demonstrating the system's capability to adjust musical characteristics based on user input.

In response to these modifications and subsequent user input at the regenerate control 804, the system displays a modified music representation 908. This representation replaces the original first music representation 132 and visually represents a modified instance of generated audio 130 created based on the updated vibe properties 128 defined via the vibe description window 802.

Although described with respect to specific examples for explanatory purposes, the described and illustrated examples are not limiting. The vibe description window 802 is designed to accommodate a wide range of customization options, enabling users to define any suitable combination of attributes 230 and properties 232. This flexibility extends beyond the predefined fields shown in the illustrated examples, and the audio generation system 116 is configured to permit the addition of custom attributes and properties based on user preferences or specific project requirements.

For instance, users may have the option to add new attribute categories beyond the standard genre, instruments, mood, and energy fields. These custom attributes could include more specific musical elements such as harmonic complexity, rhythmic patterns, or cultural influences. Similarly, the properties within each attribute category may be expanded or customized to provide a more nuanced description of the desired musical characteristics.

The audio generation system 116 is thus able to ensures that content creators have the tools to precisely define the musical qualities they envision for their video projects. This level of flexibility and control allows for the generation of highly tailored background music that closely aligns with the creator's artistic vision and the specific needs of each segment in the video data 118.

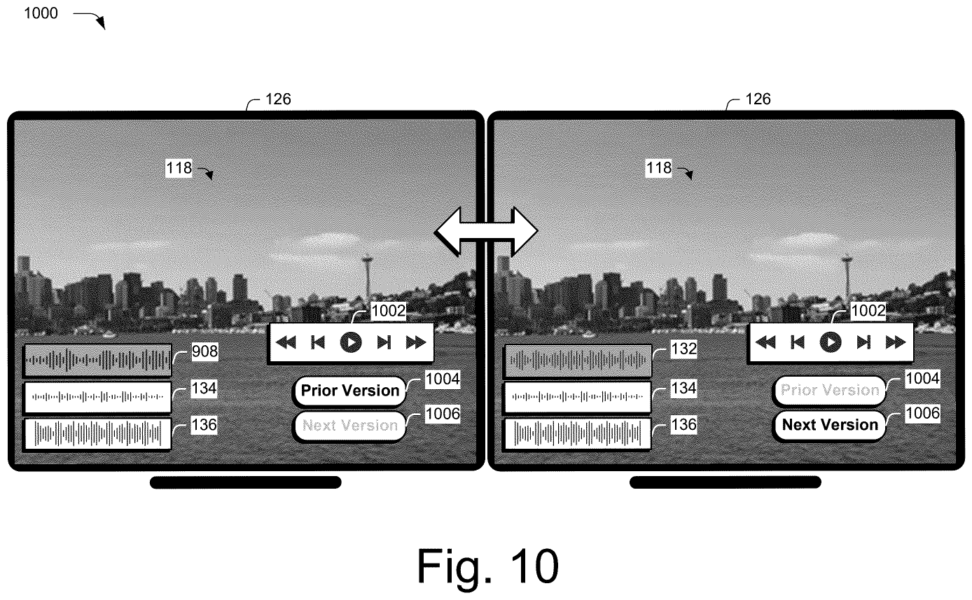

FIG. 10 illustrates an example system 1000 that depicts a user interface with controls for switching between different versions of audio generated by the audio generation system 116 based on input to the vibe description window 802. In the illustrated example of FIG. 10, different instances of the user interface 126 are depicted, where each instance displays a different version of a musical composition included in the generated audio 130, modified based on input to the vibe description window 802 and selection of the regenerate control 804. Specifically, user interface 126 is depicted as including playback controls 1002, which are selectable to control playback of the video data 118 and generated audio 130 (e.g., playback of a musical composition represented by a selected music representation).

In the illustrated example of FIG. 10, the left instance of the user interface 126 depicts a scenario where the modified music representation 908 is currently selected for playback with the video data 118. The user interface 126 further includes a prior version control 1004 and a next version control 1006, which are individually selectable to cycle between different instances of generated audio 130 (e.g., as created by the audio generation system 116 based on modified vibe properties 128 defined by input to the vibe description window 802). Continuing the examples described with respect to FIGS. 8 and 9, the left instance of the user interface 126 includes a greyed-out version of next version control 1006, indicating that the next version control 1006 is not selectable (i.e., because the modified music representation 908 represents a most recent iteration of the specific musical composition).

The right instance of the user interface 126 depicts an instance where input at the prior version control 1004 in the left instance of the user interface 126 is selected. As depicted in the right instance of the user interface 126, the modified music representation 908 is replaced by the first music representation 132, indicating that a prior version of the musical composition represented by modified music representation 908 is now being output with the video data 118. Similarly, the right instance of the user interface 126 depicts the prior version control 1004 as being grayed-out, such that the prior version control 1004 is not selectable (i.e., because the first music representation 132 represents an original instance of a musical composition in the generated audio 130 generated based on the original vibe properties 128).

In this manner, the audio generation system 116 enables users of the computing device 104 to conveniently switch between different iterations of a musical composition included in generated audio 130, offering a convenient interface for identifying the ideal audio to output during playback of the video data 118. Although not depicted in FIG. 10, in some implementations a selected music representation is further displayed with information describing the vibe properties 128 that were used by the audio generation system 116 when generating the musical composition identified by the selected music representation.

In some implementations, the user interface 126 provides additional controls and functionality to enhance the music generation and editing process, offering users greater flexibility in tailoring the generated audio 130 to their specific needs. For instance, the user interface 126 may include stretch and condense controls that allow users to modify the duration of a selected musical composition. For instance, a user could select a portion of a music representation and use a drag interaction to extend it. The audio generation system 116 would then continue the generation, seamlessly adding additional audio to the end of the selected segment. This functionality leverages the capability of the underlying machine-learning system 120 to extend existing audio in a coherent manner.

Alternatively or additionally, the audio generation system 116 is configured to output controls in the user interface 126 that support cut and “inpaint” functionality. For instance, the user interface 126 is configurable to include controls that enable users to select a region of a music representation that the users wish to modify or replace. By activating an inpaint control, users instruct the audio generation system 116 to regenerate just the selected portion of generated audio 130, potentially with modified vibe properties 128. This feature, known as “inpainting” in machine learning terminology, allows for targeted refinement of specific sections within a musical composition without affecting the rest of the generated audio 130.

Alternatively or additionally, the user interface 126 is configurable to include a loop control. When activated, the loop control instructs the audio generation system 116 to generate seamlessly looped musical compositions. Advantageously, a loop control enables a user to specify a number of times they want generated audio 130 to repeat by clicking the loop control and dragging to extend the musical composition's duration. This functionality is particularly useful for creating background music that needs to play continuously for an extended period (e.g., an entire playback duration of the video data 118).

In some implementations, to provide users with control over the variation in regenerated music, the user interface 126 is configurable to include a similarity slider. Such a similarity slider allows users to specify how closely they want regenerated versions to resemble the original composition (e.g., specify a deviation from a random seed that was used by the audio generation system 116 to generate a musical composition in generated audio 130). For example, a user might request several variations that are similar to a preferred output but with slight differences, or they might seek more diverse alternatives that fit the same prompt but explore different keys, tempos, styles, and so forth.

These controls and functionalities offered by the audio generation system 116 via user interface 126 significantly expand the creative possibilities available to users relative to conventional systems. By offering fine-grained control over the generation and modification of musical compositions, the system empowers content creators to achieve precisely the audio accompaniment they envision for their video projects, all within an intuitive and interactive interface.

Having considered example systems and techniques for vibe-guided music generation for video data, consider now example procedures to illustrate aspects of the techniques described herein.

### Example Procedures

The following discussion describes selective content recording techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following description, reference is made to FIGS. 1-10.

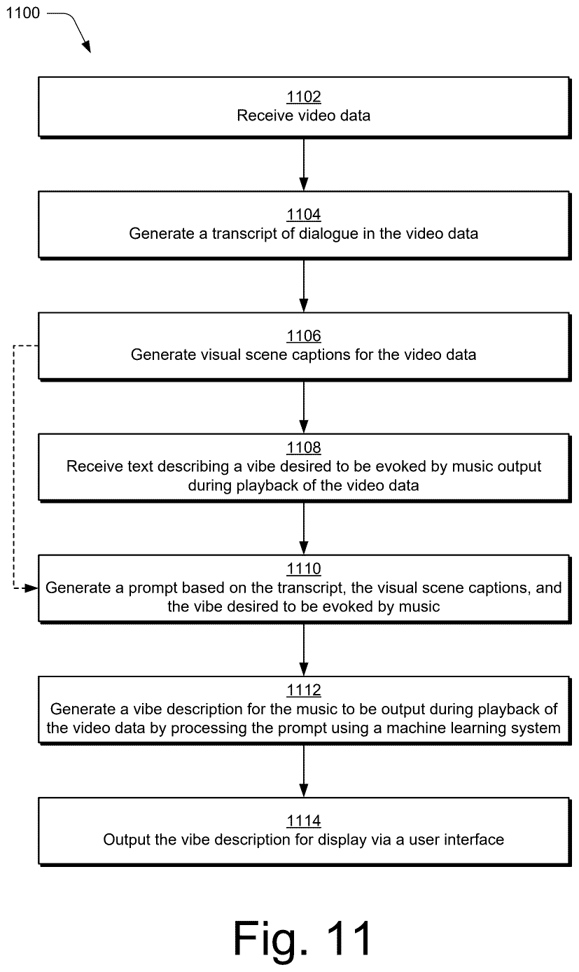

FIG. 11 depicts a procedure 1100 in an example implementation of vibe-guided music generation for video data. To begin, video data is received (block 1102). The audio generation system 116, for instance, receives video data 118 from the computing device 104 via the network 106.

A transcript of dialogue in the video data is then generated (block 1104). The transcription module 202, for example, processes the audio content of the video data 118 to generate a video transcript 204, as described in relation to FIG. 2. Visual scene captions for the video data are generated (block 1106). The caption module 206, for instance, analyzes the visual content of the video data 118 to produce captions 210 for each video scene 208, as illustrated in FIG. 2.

Text describing a vibe desired to be evoked by music output during playback of the video data is received (block 1108). The vibe summary 226, for instance, is received via user input at the computing device 104, similar to user input entered via the vibe summary field 422 in the user interface 126, as depicted in FIG. 4. Receipt of text describing the desired vibe to be evoked by generated audio 130 is optional, as indicated by the dashed arrow circumventing block 1108. In some implementations, the vibe summary 226 is automatically generated by the audio generation system 116.

A prompt is then generated based on the transcript, the visual scene captions, and the vibe desired to be evoked by music (block 1110). The prompt generation module 218, for example, creates a prompt 220 using a template 222 and information from the storage device 224, as depicted in FIG. 3.

A vibe description for the music to be output during playback of the video data is generated by processing the prompt using a machine learning system (block 1112). The vibe description module 228 employs the machine-learning system 120 to process the prompt 220 and generate a vibe description 122 with specific attributes 230 and properties 232, as described in relation to FIG. 2.

The vibe description is then output for display via a user interface (block 1114). The resulting vibe description 122 is presented in the vibe description window 402, allowing users to view and modify the generated attributes and properties, as illustrated in FIG. 4.

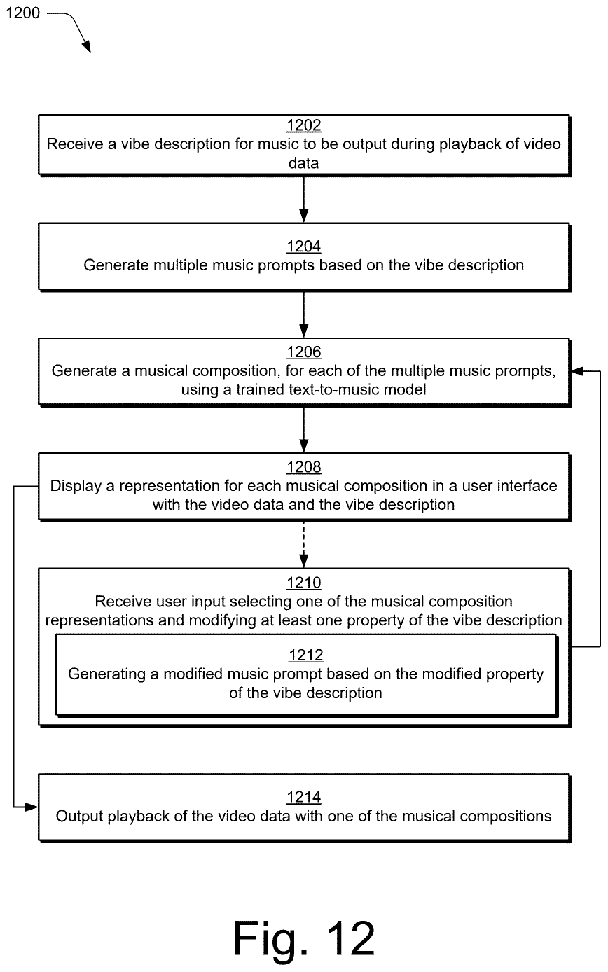

FIG. 12 depicts a procedure 1200 in an example implementation of generating and refining music for video data. To begin, a vibe description for music to be output during playback of video data is received (block 1202). For instance, vibe description 122 is received via input to the vibe description window 402.

Multiple music prompts are then generated based on the vibe description (block 1204). The prompt generation module 602, for instance, creates multiple prompts 604 using templates 606 and information from the storage device 608, as illustrated in FIG. 6.

A musical composition is generated for each of the multiple music prompts using a trained text-to-music model (block 1206). The generative audio module 610 employs the machine-learning system 120 to process each prompt 604 and create corresponding musical compositions, as described in relation to FIG. 6.

A representation for each musical composition is displayed in a user interface with the video data and the vibe description (block 1208). The user interface 126 presents the video data 118 along with music representations such as first music representation 132, second music representation 134, and music representation 136, as shown in FIG. 8.

User input is then received selecting one of the musical composition representations and modifying at least one property of the vibe description (block 1210). This may involve user interaction with the vibe description window 802 and selection of a specific music representation, as depicted in FIG. 8.

As part of receiving user input modifying at least one property of the vibe description of a selected musical composition representation, a modified music prompt is generated based on the modified property of the vibe description (block 1212). The prompt generation module 602 creates a new prompt 604 based on the updated vibe properties 128, as illustrated in FIG. 6. Operation of block 1210 and block 1212 is optional, as indicated by the dashed arrow connecting block 1208 and block 1210. Alternatively, the flow of operations from block 1206 to block 1212 is repeatable for any suitable number of loops, allowing for iterative refinement of the generated audio 130 to best suit the video data 118.

Playback of the video data with one of the musical compositions is then output (block 1214). The user interface 126 presents the video data 118 along with the selected and potentially modified musical composition, as shown in FIG. 10. Final video data is then produced, which includes a combination of the video data 118 as synchronized with at least one instance of generated audio 130. The audio generation system 116, for instance, outputs final video data to the computing device 104 for local playback and storage, to another computing device via the network 106, or combinations thereof.

Having described example procedures in accordance with one or more implementations, consider now an example system and device to implement the various techniques described herein.

### Example System and Device

FIG. 13 illustrates an example system 1300 that includes an example computing device 1302 that is representative of one or more computing systems and/or devices that implement the various techniques described herein. This is illustrated through inclusion of the audio generation system 116. The computing device 1302 is configurable, for example, as a server of a service provider, a device associated with a client (e.g., a client device), an on-chip system, and/or any other suitable computing device or computing system.

The example computing device 1302 as illustrated includes a processing device 1304, one or more computer-readable media 1306, and one or more I/O interface 1308 that are communicatively coupled, one to another. Although not shown, the computing device 1302 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1304 is representative of functionality to perform one or more operations using hardware. Accordingly, the processing device 1304 is illustrated as including hardware element 1310 that is configurable as processors, functional blocks, and so forth. This includes implementation in hardware as an application specific integrated circuit or other logic device formed using one or more semiconductors. The hardware elements 1310 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically executable instructions.

The computer-readable storage media 1306 is illustrated as including memory/storage 1312 that stores instructions that are executable to cause the processing device 1304 to perform operations. The computer-readable storage medium is configured for storing instructions that, responsive to execution by the processing device, causes the processing device to perform operations. The memory/storage 1312 represents memory/storage capacity associated with one or more computer-readable media. The memory/storage 1312 includes volatile media (such as random-access memory (RAM)) and/or nonvolatile media (such as read only memory (ROM), Flash memory, optical disks, magnetic disks, and so forth). The memory/storage 1312 includes fixed media (e.g., RAM, ROM, a fixed hard drive, and so on) as well as removable media (e.g., Flash memory, a removable hard drive, an optical disc, and so forth). The computer-readable media 1306 is configurable in a variety of other ways as further described below.

Input/output interface(s) 1308 are representative of functionality to allow a user to enter commands and information to computing device 1302, and allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1302 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1302. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1302, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1310 and computer-readable media 1306 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1310. The computing device 1302 is configured to implement particular instructions and/or functions corresponding to the software and/or hardware modules. Accordingly, implementation of a module that is executable by the computing device 1302 as software is achieved at least partially in hardware, e.g., through use of computer-readable storage media and/or hardware elements 1310 of the processing device 1304. The instructions and/or functions are executable/operable by one or more articles of manufacture (for example, one or more computing devices 1302 and/or processing devices 1304) to implement techniques, modules, and examples described herein.

The techniques described herein are supported by various configurations of the computing device 1302 and are not limited to the specific examples of the techniques described herein. This functionality is also implementable all or in part through use of a distributed system, such as over a “cloud” 1314 via a platform 1316 as described below.

The cloud 1314 includes and/or is representative of a platform 1316 for resources 1318. The platform 1316 abstracts underlying functionality of hardware (e.g., servers) and software resources of the cloud 1314. The resources 1318 include applications and/or data that can be utilized while computer processing is executed on servers that are remote from the computing device 1302. Resources 1318 can also include services provided over the Internet and/or through a subscriber network, such as a cellular or Wi-Fi network.

The platform 1316 abstracts resources and functions to connect the computing device 1302 with other computing devices. The platform 1316 also serves to abstract scaling of resources to provide a corresponding level of scale to encountered demand for the resources 1318 that are implemented via the platform 1316. Accordingly, in an interconnected device embodiment, implementation of functionality described herein is distributable throughout the system 1300. For example, the functionality is implementable in part on the computing device 1302 as well as via the platform 1316 that abstracts the functionality of the cloud 1314.

In implementations, the platform 1316 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving video data;
generating a transcript of dialogue in the video data;
generating visual scene captions for the video data;
receiving a vibe summary, the vibe summary including text describing a vibe desired to be evoked by music to be output during playback of the video data;
generating a prompt based on the transcript of dialogue, the visual scene captions, and the vibe summary;
generating a vibe description for the music to be output during playback of the video data by processing the prompt using a machine learning system; and
outputting the vibe description for display via a user interface.

2. The method of claim 1, wherein generating the transcript of dialogue in the video data comprises processing the video data using a speech recognition engine, wherein the transcript of dialogue comprises a defined format of spoken dialogue in the video data, wherein the defined format is human-readable text.

3. The method of claim 1, wherein generating the visual scene captions for the video data comprises:
segmenting the video data into a plurality of visual scenes;
for each scene of the plurality of visual scenes:
assigning a start time and an end time to the scene; and
generating a textual description of at least one frame in the scene; and
outputting an array of objects, each object in the array of objects corresponding to a different scene of the plurality of visual scenes and including the textual description of the at least one frame in the scene, the start time for the scene, and the end time for the scene.

4. The method of claim 3, wherein segmenting the video data into the plurality of visual scenes comprises:
uniformly sampling frames from the video data at a defined rate;
generating an embedding for each frame sampled from the video data using a contrastive machine learning system;
clustering the generated embeddings using affinity propagation;
merging similar frames based on the clustering; and
outputting merged frames as a scene of the plurality of visual scenes.

5. The method of claim 3, wherein generating the textual description of the at least one frame in the scene comprises identifying a middle frame in the scene and tasking a trained large multimodal model to generate a description of the middle frame in the scene.

6. The method of claim 1, further comprising outputting an input field in the user interface, wherein receiving the vibe summary comprises receiving the text describing the vibe desired to be evoked by the music to be output during playback of the video data via the input field.

7. The method of claim 1, wherein the vibe description includes a plurality of categories that each define a different attribute of the music to be output during playback of the video data, wherein the vibe description includes at least one parameter defining each of the plurality of categories.

8. The method of claim 7, wherein the plurality of categories include one or more of genre, instruments, mood, theme, energy level, tempo, and volume.

9. The method of claim 7, wherein outputting the vibe description for display via the user interface comprises:
enabling user input to modify at least one of the plurality of categories or the at least one parameter; and
outputting controls that are selectable to generate the music to be output during playback of the video data based on the at least one parameter for each of the plurality of categories.

10. The method of claim 1, further comprising receiving a selection of at least one scene in the video data, wherein generating the vibe description for the music to be output during playback of the video data comprises receiving the vibe summary for the selected at least one scene and generating the prompt for the selected at least one scene using the vibe summary for the selected at least one scene, a portion of the transcript corresponding to the selected at least one scene, and the visual scene captions for the selected at least one scene.

11. The method of claim 1, further comprising:
generating, using a machine learning system, multiple music prompts based on the vibe description, the transcript of dialogue, and the visual scene captions;
generating, for each music prompt of the multiple music prompts, a musical composition using a trained text-to-music model;
displaying a representation of each of the generated musical compositions in the user interface with the vibe description used to generate the musical compositions; and
outputting playback controls via the user interface that are selectable to preview how a selected one of the generated musical compositions will sound during playback of the video data.

12. The method of claim 11, further comprising outputting an input field in the user interface that is configured to receive user input defining a number of music prompts to be generated, wherein generating the multiple music prompts comprises generating the number of music prompts.

13. The method of claim 11, wherein generating the musical composition using the trained text-to-music model comprises providing the music prompt, a specified duration, and a random seed as input to the trained text-to-music model.

14. The method of claim 11, further comprising outputting options via the user interface to extend or condense a duration of the selected one of the generated musical compositions.

15. The method of claim 11, wherein each of the multiple music prompts instruct the trained text-to-music model to generate a different instance of music.

16. The method of claim 11, further comprising receiving user input selecting one of the musical compositions via the user interface, receiving user input modifying at least one parameter in the vibe description, and regenerating the selected one of the musical compositions based on the modified at least one parameter in the vibe description.

17. The method of claim 16, further comprising outputting controls via the user interface that are selectable to switch between original and regenerated versions of the selected one of the generated musical compositions.

18. The method of claim 16, wherein receiving the vibe summary comprises automatically generating the text describing the vibe desired to be evoked by music to be output during playback of the video data based on at least one of the video data, the transcript of dialogue, or the visual scene captions.

19. A computer-readable storage medium storing instructions that are executable by at least one processing device to perform operations comprising:
receiving a vibe description for music to be output during playback of video data, the vibe description including a plurality of categories that each define a different attribute of the music to be output during playback of the video data and at least one parameter defining each of the plurality of categories;
generating, using a machine learning system, multiple music prompts based on the vibe description;
generating, for each music prompt of the multiple music prompts, a musical composition using a trained text-to-music model;
displaying a representation of each of the generated musical compositions in a user interface with the vibe description;
displaying playback controls via the user interface that are selectable to preview how a selected one of the generated musical compositions will sound during playback of the video data; and
outputting playback of the video data with the selected one of the generated musical compositions responsive to receiving input at the playback controls.

20. A system comprising:
one or more processors; and
a computer-readable storage medium storing instructions that are executable by the one or more processors to perform operations comprising:
receiving video data, a transcript of dialogue in the video data, and visual scene captions for the video data;
generating a prompt based on the transcript of dialogue and the visual scene captions;
generating a vibe description for music to be output during playback of the video data by processing the prompt using a machine learning system;
generating multiple music prompts based on the vibe description;
generating, for each music prompt of the multiple music prompts, a musical composition using a trained text-to-music model;
displaying a representation of each of the generated musical compositions in a user interface with the vibe description; and
outputting playback of the video data with a selected one of the generated musical compositions via the user interface.
